(19) United States
(12) Patent Application Publication
(10) Pub. No.: US 2002/0029254 A1
(43) Pub. Date: Mar. 7, 2002

(54) Method and system for managing personal information

(76) Inventors: Terry L. Davis, Scottsdale, AZ (US); Steven E. Smith, Phoenix, AZ (US); Yvan Y. Baudoin, Phoenix, AZ (US); Ole Sorensen, Phoenix, AZ (US)

Correspondence Address: R. Lee Fraley, Snell & Wilmer L.L.P., One Arizona Center, 400 E. Van Buren, Phoenix, AZ, 85004-2202, US

(21) Appl. No.: 09/946,220

(22) Filed: Sep. 5, 2001

Related U.S. Application Data
(60) Provisional application No. 60/230,404, filed on Sep. 6, 2000.
(60) Provisional application No. 60/238,064, filed on Oct. 5, 2000.

(51) Int. Cl. G06F 15/16

(52) U.S. Cl. 709/217; 709/203

(57) ABSTRACT

A method and system is provided for controlling and managing the storage and retrieval of personal information in a computer network environment and that is configured for supporting any number of applications supplied by any number of vendors. An exemplary method and system can provide an open-ended capability for an individual to define, securely store, retrieve and/or modify information pertaining to the activities of the individual, such as those relating to computer access, electronic commerce or Internet based information searching, or the communication with other parties via electronic mechanisms. In addition, an exemplary method and system can provide significant improvement to prior art server-based and local client-based methodologies of managing stored information through the utilization of smart card-like devices having server-like processing capability, as well as physical security and mobility aspects provided by the size and portability of the user smart card device. Further, an exemplary method and system can be applied to the management of multiple network personal data applications, such as, for example, wallets, digital certificates, user profile information, contacts, web page address management, and the like. In accordance with an exemplary embodiment, a system for managing personal information can include a user device, an access device, a communication network and a host server unit. The user device suitably comprises a secure, intelligent portable device, such as a smart card, configured for containing storage of personal information. In addition, the user device can be suitably configured with server functionality such that multiple applications can be conducted on the user device, rather than solely on the access device.

### CROSS REFERENCE TO RELATED APPLICATIONS

This application claims priority from prior pending U.S. Provisional Application Ser. No. 60/230,404, entitled “Mobile Personal Information Management System and Methods Therein,” filed Sep. 6, 2000, and from prior pending U.S.

Provisional Application Ser. No. 60/238,064, entitled “Mobile Personal Information Management System and Methods Therein,” filed Oct. 5, 2000, both of which are hereby incorporated herein by reference.

### FIELD OF THE INVENTION

The present invention relates generally to the management of personal information, and in particular, to a mobile personal information and management system and method for use by entities and individuals.

### BACKGROUND OF THE INVENTION

The proliferation of various banking and financial credit services, purchasing clubs, frequent traveler programs and the like has resulted in a large number of identification cards, and their related accounts, passwords and other user information needing to be maintained and accessed by the card user. This proliferation of identification cards has increased the risk that various of these cards can be lost, misplace or stolen. Further, the security risk increases due to the amount of information immediately available to the holder of the card.

Attempts have been made to consolidate the plurality of identification cards with a single card in an attempt to save space and minimize convenience. For example, a system 100 for representing a plurality of credit cards on a single card, as disclosed in U.S. Pat. No. 4,700,055, issued Oct. 13, 1987, is shown in FIG. 1. Credit card system 100 includes a credit card 102 for communicating to a credit card reader 104 that is controlled by a console 106. A local microprocessor 108, e.g., a point-of-sale terminal, operates with console 106 to interpret data from card 102. A verification device 110 can be included to recognize the data on card 102 to verify with the card provider, and a printer 114 can be included to provide invoices and credit card reports. Microprocessor 108 can communicate with a remote central computer 116 through a modem 112 to enable central computer 116 to determine which of various credit card accounts are associated with card 102. Such credit card systems are very dependent on the security of the communication network between remote computer 116, rather than the control of security by the card user. Further, such card programs are typically limited in the amount of data that is available locally to the user, e.g., limited to user identity, cannot be readily updated, or require expensive, specialized equipment to change the memory contents on the cards.

More recently, many card programs, such as those described above, have been adapted in a computer communications network such as the Internet, and thus require an individual to repeatedly enter the same user information, such as a user name and password, through a client device. These commerce-based activities can include, among other activities, the purchasing of services and goods from an online merchant, interacting with service providers, e.g., online investment firms, managing funds online with a bank, and retrieving information and data from databases for further use. In addition, browsers, search tools, and other similar types of utilities are included to allow individuals to use electronic devices to communicate with providers of information throughout the communication network. Individuals in such environments can also communicate with other individuals or entities through such mechanisms as e-mail and chat rooms.

However, in the process of performing all these various activities, the need to present or to access certain types of data and information of the user continually presents itself. Moreover, various tools and utilities are necessary with the client devices to meet the requirements to repeatedly manage pertinent data when executing these online exchanges.

In a client-server type of environment such as the Internet, data can be controlled by and located in either a host/server, i.e., a device remote to the user, or in a client device, i.e., a device local to the user. Data retention in a server allows individuals to perform their online activities from any device that can gain access to that server. This configuration can provide users with mobility, but unfortunately dictates that the security of the user data is relegated to an entity that is beyond the immediate control of the user, e.g., the information is stored on merchant servers. Meanwhile, storing and managing data in a local client device provides a degree of security control for the user but minimizes and/or complicates the mobility of the individual because that user must re-establish his or her personal environment on any new device that is used to communicate with the network. Moreover, having locally stored information, such as account numbers and passwords, on personal computer devices can provide the opportunity for unauthorized parties to access the information when the personal computer devices communicate to remote computer systems.

An approach for remotely accessing data records, such a health information, and storing in a client device, such as a smart card, is disclosed in U.S. Pat. No. 5,995,965, issued Nov. 30, 1999. With reference to FIG. 2, this system includes a smart card device 200 having a processor, I/O unit, and various memory and programming components, a reader 202 having a local processor, and a local processing unit 204 also having a processor, I/O unit, and various memory and programming components. Processing unit 204 is configured to communicate with an input terminal 206 and a display terminal 208, as well as a remote processing unit 212 through Internet network 210.

During use, an individual uses smart card 200 to activate processing unit 204 which automatically accesses remote processing unit 212 through Internet network 210 to retrieve data and information pertaining to the individual. This data may be suitably downloaded to memory of smart card 200 for further use by the individual.

While the storing and managing of data in smart card 200 provides a degree of security control for the individual, the mobility of the individual is minimized and/or complicated since the individual must re-establish his or her personal environment on any new device 204 that is used to communicate with network 210.

As a result, the prior art methods for managing personal information have various disadvantages that are inherent in the types of devices and techniques that are implemented. However, additional deficiencies exist to those set forth above.

For example, current methods are configured to require exclusive control of the interface to the smart card devices, and thus do not provide for a server-like access to the smart card device and the data stored therein. In addition, these current methods include fixed data formats that are strictly enforced and/or limited by the application, and therefore, do not readily provide for updates or easy migration to new smart card technology when such technology is developed. Further, prior art methods significantly limit the usefulness of a smart card that can be configured for multiple applications to that of a single application smart card or a single vendor.

For example, while a smart card may be capable of multiple applications, prior art systems for controlling information on the smart card are configured to take over operation of the smart card to exclusively operate one application at a time, i.e., if an application is running, the control system will shut that application down before starting-up another application.

Accordingly, a need exists for an improved method and system that maintains the benefits of the existing approaches, and yet augments those approaches with new capabilities to negate the shortcomings that presently exist. In addition, a need exists for an improved method and system for managing personal information that can provide a server-like access to a smart card, as well as being capable of supporting multiple applications supplied by any number of vendors.

### SUMMARY OF THE INVENTION

The method and system for managing personal information overcomes many of the problems of the prior art. In accordance with various aspects of the present invention, a method and system is provided for controlling and managing the storage and retrieval of personal information in a computer network environment and that is configured for supporting any number of applications supplied by any number of vendors. An exemplary method and system can provide an open-ended capability for an individual to define, securely store, retrieve and/or modify information pertaining to the activities of the individual, such as those relating to computer access, electronic commerce or Internet based information searching, or the communication with other parties via electronic mechanisms. In addition, an exemplary method and system can provide significant improvement to prior art server-based and local client-based methodologies of managing stored information through the utilization of smart card-like devices having server-like processing capability, as well as physical security and mobility aspects provided by the size and portability of the user smart card device. Further, an exemplary method and system can be applied to the management of multiple network personal data applications, such as, for example, wallets, digital certificates, user profile information, contacts, web page address management, and the like.

In accordance with an exemplary embodiment, a system for managing personal information can include a user device, an access device, a communication network and a host server unit. The user device suitably comprises a secure, intelligent portable device, such as a smart card, configured for containing storage of personal information. In addition, the user device can be suitably configured with server functionality through operation with the access device such that any number of applications can be conducted on the user device, from any number of application vendors. In addition, the system for managing personal information can be configured with data compression techniques for data storage on the user device independent of the type of user device and the format of the user data.

### BRIEF DESCRIPTION OF THE DRAWINGS

A more complete understanding of the present invention may be derived by referring to the detailed description when considered in connection with the figures, where like reference numbers refer to similar elements throughout the figures, and:

FIG. 1 illustrates a prior art credit card system for communicating with a remote computer system;

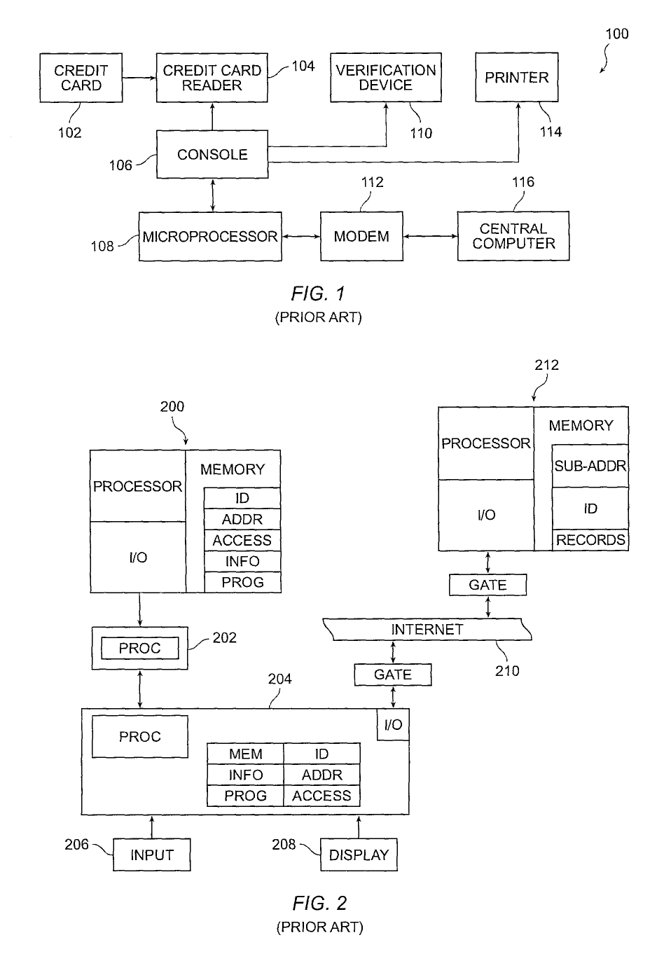

FIG. 2 illustrates a prior art smart card system for obtaining data from a remote computer system;

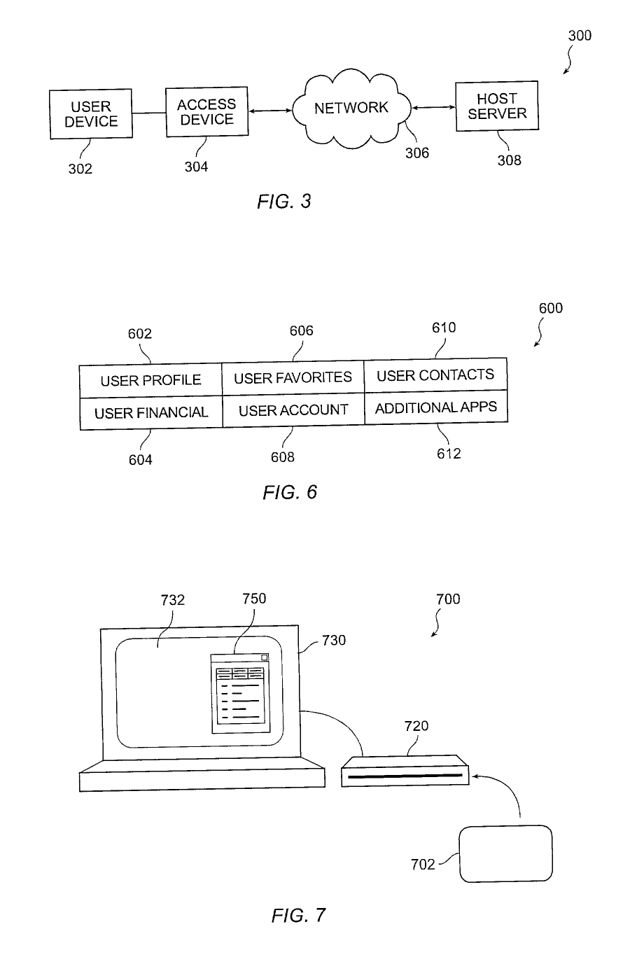

FIG. 3 illustrates an exemplary embodiment of a personal information management system in accordance with the present invention,

FIG. 4 illustrates another exemplary embodiment of a personal information management system in accordance with the present invention;

FIG. 5 illustrates an exemplary embodiment of a personal information management system configured with an exemplary host server unit in accordance with the present invention;

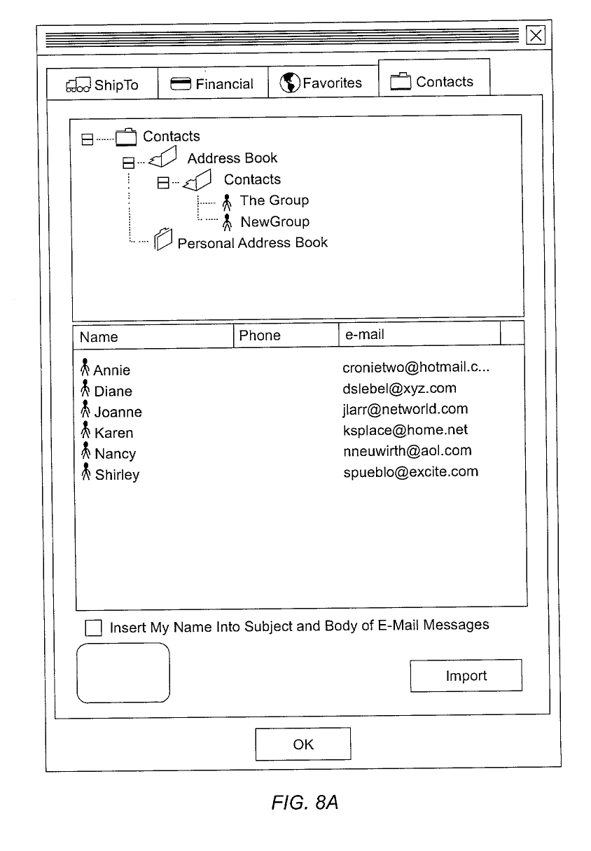

FIG. 6 illustrates exemplary applications for a user device in accordance with an exemplary embodiment of the present invention;

FIG. 7 illustrates another exemplary embodiment of a personal information management system in accordance with the present invention; and

FIGS. 8A-8D illustrate exemplary displays of user applications in accordance with an exemplary embodiment of the present invention.

### DETAILED DESCRIPTION OF EXEMPLARY EMBODIMENTS

The present invention may be described herein in terms of various software modules, functional block components and processing steps. It should be appreciated that such modules, components and steps may be realized by any number of hardware components configured to perform the specified functions. For example, the present invention may employ various integrated circuit components, servers, switches, routers and signal processors, input/output devices, data storage and memory devices, terminals, security devices, and the like, which may carry out a variety of functions under the control of one or more microprocessors or other control devices. In addition, it should be noted that the present invention may be practiced in any number of data storage and retrieval contexts and that the information management system described herein is merely one exemplary application for the invention. For example, the present invention may be applicable to any secure, intelligent portable device configured for containing information regarding an individual or entity. Further, such general techniques that may be known to those skilled in the art are not described in detail herein.

As discussed above, current methods for managing personal information are configured to require exclusive control of the interface to the user devices, and thus do not provide for a server-like access to the user device and the data stored therein. In addition, these current methods include fixed data formats that are strictly enforced and/or limited by the application, and therefore, do not readily provide for updates or easy migration to new smart card technology when such technology is developed. Further, prior art methods significantly limit the usefulness of a multi-application smart card to that of a single application smart card or of a single vendor. However, in accordance with various aspects of the present invention, a method and system can be provided for controlling and managing the storage, retrieval and use of personal information in a computer network environment, with the system being configured for supporting any number of applications supplied by any number of vendors.

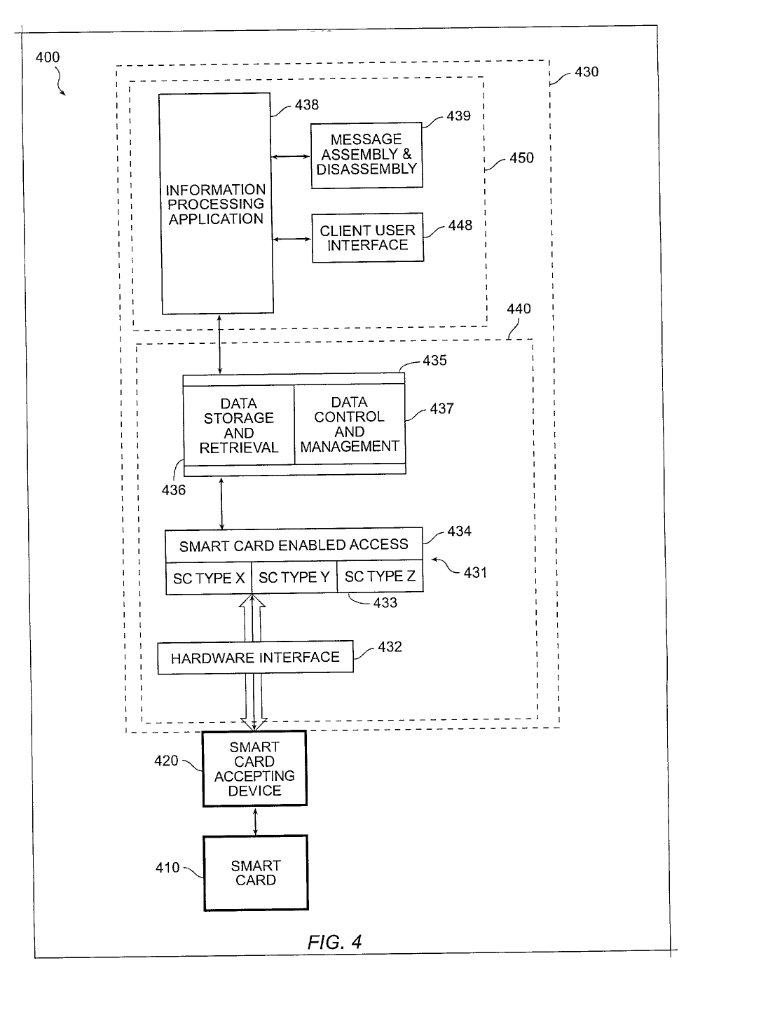

In accordance with an exemplary embodiment, with reference to FIG. 3, a system 300 for managing personal information can include a user device 302, an access device 304, a communication network 306 and a host server unit 308. User device 302 suitably comprises a secure, intelligent portable device configured for storage of personal information. User device 302 can comprise various devices configured to provide for portability to the user. For example, in accordance with an exemplary embodiment, user device 302 can comprise a smart card device.

However, other portable devices can be suitably implemented as well. To facilitate the local processing and use of data in a secure environment, as will be discussed in more detail below, user device 302 can be configured with the functionality of a server configured for operation of multiple user applications.

Access device 304 suitably comprises any local client computing device configured to interface between user device 302 and host server 308. Access device 304 suitably comprises a user accepting device for communicating with user device 302 and a local processor device for processing data retrieved from user device 302. Access device 304 can comprise any device for the storage, retrieval and processing of information, such as a personal computer (PC), a personal data assistant (PDA), cellular telephones, or other processor-based devices. In addition, access device 304 is suitably configured for displaying and using the data and information obtained from user device 302. In addition, access device 304 can be configured to provide server-like functions to user device 302 for operation of multiple user applications. Moreover, access device 304 can be configured to utilize data compression techniques such that user data can be stored independent of the type of user device, e.g., independent of smart card brands and PDAs, as well as the data format, i.e., independent of the length of the data.

Network 306 can suitably comprise any conventional network configured for the transfer of data and information between two devices, such as a user device 302 or access device 304 and a host server 308. Thus, network 306 can comprise a local communication network, or an IP network. In accordance with an exemplary embodiment, network 306 comprises an Internet-based network.

Host server unit 308 suitably comprises any computer server system configured for the managing, storage, retrieval and use of data and information. In accordance with an exemplary embodiment, server unit 308 suitably comprises a remote server such as, for example, a merchant server, a remote database server, financial services server and the like.

During operation of system 300, a user may utilize user device 302 to suitably access, retrieve and use information contained on user device 302 and host server unit 308. This operation can include the use of one or more applications configured within the server-like functions of user device 302. Such applications can also be suitably displayed by access device 304 for further use. As a result, system 300 can be configured for controlling and managing the storage, retrieval and use of personal information in a computer network environment, with system 300 being configured for supporting any number of applications supplied by any number of vendors. In addition, system 300 can be configured for storage of user data independent of data format and the type of user device.

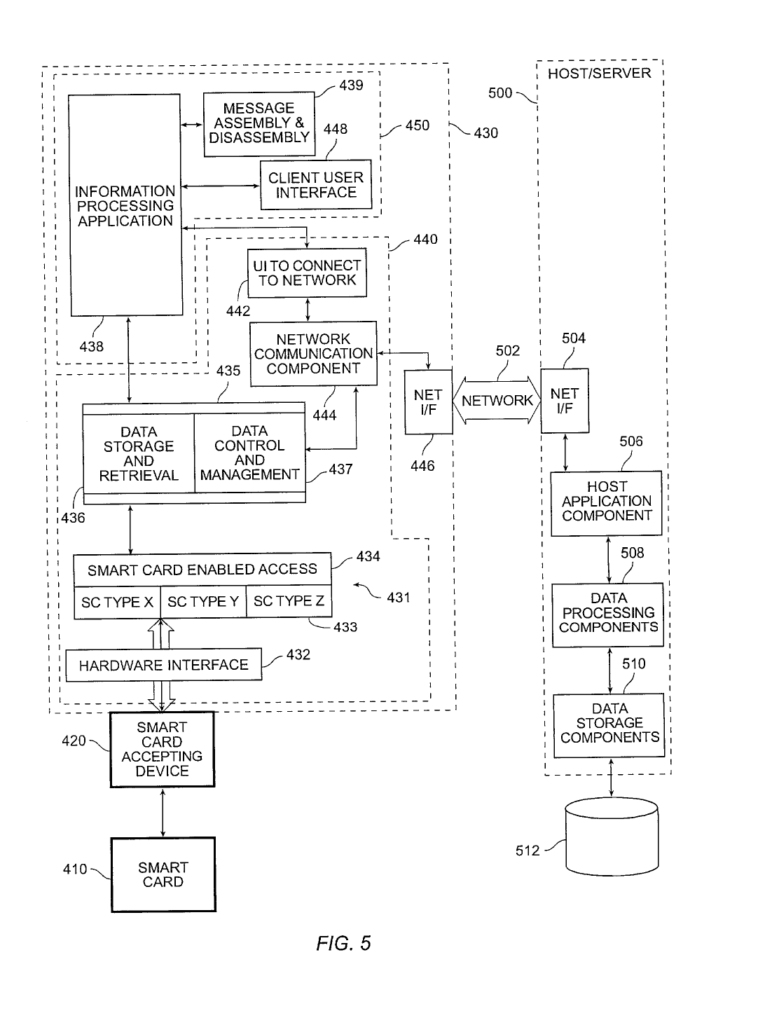

Having described in general an exemplary system for managing personal information, a more detailed description of an exemplary user device and access device can be provided. With reference to FIG. 4, an exemplary system 400 for managing personal information suitably comprises a user device 410, an accepting device 420 and an access device 430. User device 410 suitably comprises a secure, intelligent portable device configured for storage of personal information. In accordance with an exemplary embodiment, user device 410 comprises a smart card device. However, it should be understood that user device 410 can comprise any intelligent, portable device, such as PDAs, configured for storage and use of personal information.

To facilitate the local processing and use of data in a secure environment, smart card device 410 is configured with the functionality of a server to provide for operation and control of multiple applications. In accordance with an exemplary embodiment, smart card device 410 can be configured through an interface included within access device 430 that facilitates the server-like functionality of smart card device 410. As a result, smart card device 410 can suitably organize, manage and store information locally in a portable device, rather than requiring such functions to be strictly performed on access device 430. In addition, such applications can be operated independently from one another, i.e., one application does not need to be halted before another application can be initiated.

Accepting device 420 suitably comprises an interface device configured for facilitating the communications between user device 410 and access device 430. Accepting device 420 can comprise any device for accepting communications between user device 410 and access device 430, such as various commands, responses, data transfers, and control signals. In addition, while accepting device 420 can comprise a separate device configured for coupling to access device 430 and to user device 410, accepting device 420 can also be configured within, or a component of, access device 430.

Access device 430 suitably comprises any local client computing device configured to interface with user device 410. Access device 430 can comprise any device for the storage, retrieval and processing of information, such as a personal computer (PC), a personal data assistant (PDA), cellular telephones, or other processor-based devices. In addition, access device 430 is suitably configured for displaying and using the data and information obtained from user device 410. In accordance with an exemplary embodiment, access device 430 suitably comprises an interface module 440 and a data management component 450.

Interface module 440 suitably comprises an interface module or platform configured for interfacing to smart card device 410 through accepting device 420 to receive and or transmit various commands, responses, data transfers, and control signals to and from smart card device 410. In accordance with an exemplary embodiment, interface module 440 suitably comprises a hardware interface 432, a smart card interface 431 and a data access interface 435. Through operation of interface module 440, access device 430 can suitably provide server-like functionality within smart card device 410 to facilitate operation of multiple applications.

Hardware interface 432 comprises an interface configured for facilitating the coupling of accepting device 420 to access device 430. While hardware interface suitably comprises hardware components for facilitating a physical connection, hardware interface 432 can also comprise software components and modules for facilitating connection to accepting device 420.

Smart card interface 431 suitably comprises an ubiquitous interface module configured for interfacing to the functions of smart card device 410. For example, smart card interface 431 can comprise one or more smart card communication schemes 433 configured to support various types of smart card devices, e.g., a smart card type-X, type-Y and/or a type-Z, or any other number or type of specific smart card configuration. In addition, smart card interface 431 can comprise a smart card enabled access scheme 434 which comprises an interface scheme configured to facilitate access to any type of smart card configuration.

Data access interface 435 is suitably configured for facilitating access of user data within access device 430 and can comprise any conventional device for data access. In accordance with an exemplary embodiment, data access interface 435 includes a data storage and retrieval component 436 configured for the organization, managing, and location of stored data, and a data control and management component 437 that is configured to facilitate the management and control of data through the smart card-based control mechanisms of smart card device 410. Data access interface 435 can be suitably configured with data compression techniques within data storage and retrieval component 436 that is configured not only to compress any user data, but can also store the user data independent of the type of user device 410, e.g., the type of smart card or PDA device, and independent of the length of the user data.

Data management component 450 suitably comprises a component configured for management of user data provided from smart card device 410. Data management component 450 can comprise software and/or hardware modules for managing user data. In accordance with an exemplary embodiment, data management component 450 comprises an information processing application 438, a message assembly/disassembly unit 439, and a user interface 440.

Information processing application 438 suitably comprises a module configured to interpret the context of the data being accessed, manipulated or otherwise used within access device 430. For example, data can be suitably saved, edited and stored through use of information processing application 438. In addition, a message assembly/disassembly unit 439 can be included as an agent to provide proper data formatting for the information processing application. As discussed above with respect to data access interface 435, message assembly/disassembly unit 439 can provide proper data formatting independent of the data format, i.e., independent of the length of the user data.

User interface 440 suitably comprises a user interface panel configured to permit the user to interface with the smart card device 410 through information processing application 438 for saving, editing and using stored information pertaining to that user. In accordance with an exemplary embodiment, as will be described below, user interface 440 can be configured in a “tab” format such that each application being conducted on the server of user device 410 can be suitably displayed.

Through use of exemplary system 400 for managing personal information, the user can suitably access and utilize personal information stored on user device 410 through use of access device 430. The operation of system 400 can include the use of one or more applications configured within the server-like functions of user device 410. Such applications can also be suitably displayed by access device 430 for further operation by the user. In addition to local use, i.e., use of information configured within user device 410 and access device 430, system 400 can also be configured for use with remote data and information within a host server system.

For example, with reference to FIG. 4, access device 430 can be suitably configured to communicate with a host server 500 through a communication network 502. In accordance with an exemplary embodiment, interface module 440 further comprises a network connection application 442 and a network communication component 444. Network connection application 442 suitably comprises an application module for facilitating connection of information processing application 438 to communication network 502. Network communication component 444 suitably comprises a data transfer mechanism, e.g., a driver, for facilitating the transfer of data through communication network 502. In addition, access device 430 can suitably comprise a network interface 446. Network interface 446 can suitably comprise any interface device for coupling access device 430 to communication network 502.

Communication network 502 comprises any conventional network configured for the transfer of data and information between two devices, such as a user device 410 or access device 430 and host server 500. Thus, network 502 can comprise a local communication network, or an IP network. In accordance with an exemplary embodiment, network 502 comprises an Internet-based network.

Host server unit 500 suitably comprises any computer server system configured for the managing, storage, retrieval and use of data and information. For example, server unit 500 suitably comprises a remote server such as a merchant server, a remote database server, financial services server and the like. In accordance with an exemplary embodiment, host server unit 500 can include a network interface 504, a host application component 506, a data processing component 508 and a data storage component 510 and/or 512.

Network interface 504 can suitably comprise any interface device for coupling host server unit 500 to communication network 502. For example, network interface can comprise a similarly configured device as network interface 446, or any other like interface component.

Host application component 506 suitably comprises a selected application of host server 500. For example, host application component 506 can comprise an account balance application for a banking institution, a frequent flier program, or a shopping basket from a merchant store. As a result, access device 430, and thus user device 410, can suitably access a particular application under operation within host application component 506.

Host server 500 may also include one or more data processing components 508 suitably configured for processing personal information. Data processing components 508 are suitably configured for providing functionality compatible with data storage and retrieval component 436, e.g. a component configured for the organization, managing, and location of stored data, and with data control and management component 437, e.g., a component that is configured to facilitate the management and control of data.

Host server 500 may also include one or more data storage components 510 that are configured for the storage of data locally on host server 500. Data storage component 510 can comprise any conventional data storage device, module or component. In addition to locally stored data on data storage components 510, host server 500 can further include remote data storage components 512.

As described above, the exemplary method and system can facilitate the controlling and managing of personal information, including the storage and retrieval of personal information, in a computer or computer network environment. In addition, the method and system can be configured for supporting any number of applications supplied by any number of vendors. An exemplary method and system can provide an open-ended capability, i.e., independent of type of application, user device or data format, for an individual to define, securely store, retrieve and/or modify information pertaining to the activities of the individual, such as those relating to computer access, electronic commerce or Internet based information searching, or the communication with other parties via electronic mechanisms. Further, an exemplary method and system can provide significant improvement to prior art server-based and local client-based methodologies of managing stored information through the utilization of smart card-like devices having server-like processing capability, as well as physical security and mobility aspects provided by the size and portability of the user smart card device.

In accordance with one aspect of the present invention, the exemplary method and system can be applied to the management of multiple applications comprising network related personal data, such as, for example, wallets, digital certificates, user profile information, contacts, web page address management, and the like. In accordance with this aspect, with reference again to FIG. 3, user interface 410 can comprise a user interface panel configured to permit the user to interface with the smart card device 410 through the information processing application 438 for saving, editing and using stored information pertaining to that user. In accordance with an exemplary embodiment, user interface 440 can be configured to display each feature or application being conducted by smart card device 410.

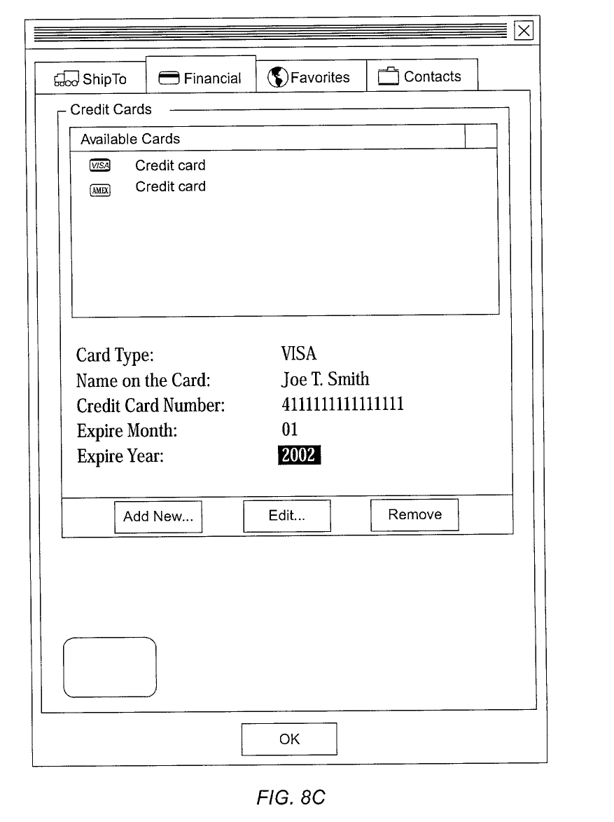

For example, with reference to FIG. 7, a system 700 for managing personal information can be configured such that a user device 702, e.g., a smart card, can be inserted into an accepting device 720, e.g., a smart card reader, that is coupled to an access device 730, e.g., a personal computer. Access device 730 suitably includes a user interface 410 configured to provide a display 732 such that a user application 750 can be suitably displayed, e.g. in a “tab” format, and acted upon by the user.

To facilitate the local processing and use of data in a secure environment, smart card device 410 is configured with the functionality of a server. As a result, smart card device 410 can suitably organize, manage and store information locally in a portable device, rather than requiring such functions to be performed only on access device 430. In accordance with an exemplary embodiment, user device 410 suitably comprises a plurality of user applications that are configured to operate within server-like functions enabled by interface module 440 of access device 430. Such server-like functionality within user device 410 can operate independent of the number or type of application. In addition, smart card device can be configured for the encryption, compression and storage of user data.

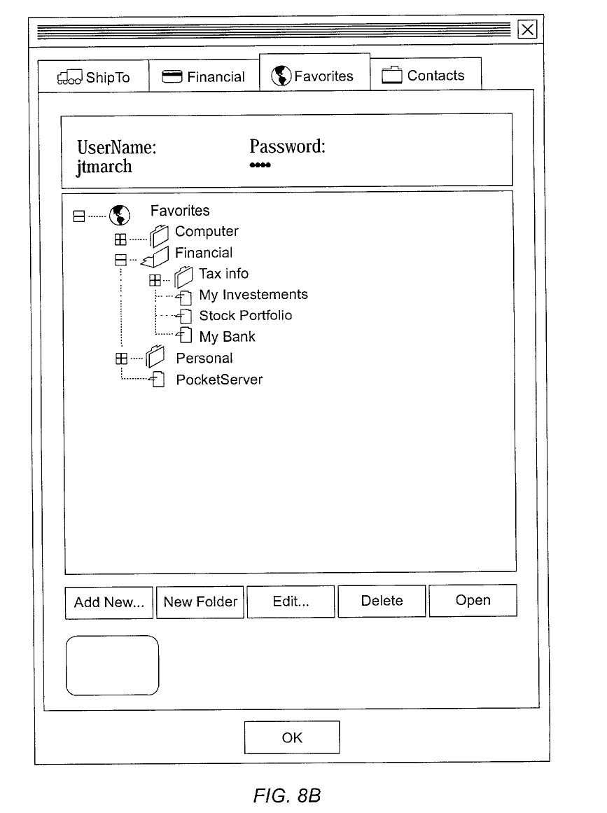

For example, with reference to FIG. 6, user device 410 can include a user profile application 602 configured to provide the user with the ability to store one or more user profiles. These profiles can be configured to supply the address, phone number and other shipping information of the user to the web sites of other persons or entities that require that information for providing user with the requested information, goods and/or services, e.g., the information can be suitably provided to a merchant host server for conducting an e-commerce transaction. In accordance with an exemplary embodiment, user profile application 602 can be configured to automatically populate the request forms of various web sites. As a result, the user is not required to have to re-enter the personal profile information for each new application or transaction with a new merchant. In addition, user profile application 602 can be configured for multiple addresses, e.g., business and home.

In addition, user device 410 can include a user financial application 604 configured to store financial data, such as credit card information. Accordingly, the user can simply import credit card information from user financial application 604 directly to another e-commerce web site or other vendor to consummate a financial transaction. This ability to populate the vendor site with the credit card information significantly reduce the number of times the user must access their personal credit card. User financial application 604 can be configured for the storage of one or more credit card profiles, including the expiration date, card type and number, and cardholder. In addition, user financial application 604 provides a place to securely store the credit card information of the user, such as through encryption techniques, when performing online e-Commerce transactions.

User device 410 can also include a user favorites application 606 to facilitate the organizing and managing of web site (URL) information, including user names and passwords that may be required by various third party sites. The user can enter and save a particular site address, user ID, and password information relative to any web site. The information can be displayed in a folder/tree format, making it format-compatible with industry standard browser applications such as, for example, Microsoft Internet Explorer. Web site address information stored on the smart card can be exported to a favorites list that is provided by one of these browser applications through an interface that allows communication with user favorite application 606. In addition, user favorite application 606 also supports the organization of favorites under folders for better organization. A user can select an address and invoke his/her default browser and access the web site that is selected.

In addition, user device 410 can include a user account application 608 that is suitably configured to store data and information pertaining to various merchants or other e-commerce companies. For example, user account application 608 can suitably store credit card issuer data, e.g., data and information provided by a merchant banker, or other e-commerce merchants. In addition, user account application 608 can provide for personal investment accounts, checking and savings accounts, loan or other financing accounts, and any other issuer service accounts. In accordance with an exemplary embodiment, this stored information can be configured to prevent modification or deletion by the user, thus ensuring some authority and control by the account issuer or e-commerce merchants. In addition, this data can be updated from the web site of the card issuer or e-commerce merchants, such as through a host server 500.

User device 410 can also include a user contacts application 610 to facilitate the organizing and managing of contact information. For example, the user can enter and save contact information such as e-mail addresses, phone numbers and postal addresses of various business and friendly contacts. The information can be displayed in a folder/tree format, making it format-compatible with industry standard contact applications, such as, for example, Microsoft Outlook. Address book information can be imported from the standard applications through an interface, such as interfaces 504, 446, 435, and 431 that allows communication with user contacts application 610. In addition, the organization of contacts into groups for easy addressing can be realized. Accordingly, a user can select a contact or a group and invoke his/her default e-mail application and send e-mail to the selected recipients.

It should be noted that the above user applications are merely for illustration purposes, and that various of the application can be suitably altered, deleted, combined or otherwise modified in accordance with various exemplary embodiments of the present invention. Additional user applications 612 can also be suitably included in accordance with various other exemplary embodiments of the present invention. For example, user device 410 can also include a user shipping application that is configured to store user address information, including multiple addresses of user, to facilitate e-commerce web sites to automatically import information. This imported information can be suitably stored in various address fields within the shipping application, and can be suitably imported from the appropriate fields as requested from e-commerce web sites. In addition, a lost and found application can be included to facilitate the return or retrieval of a lost user device 410. Moreover, more specific applications can be provided, such as a banking application that can list information on how to access bank services, or applications relating to a user's workplace information. Accordingly, any other subset of information can be included as an application within user device 410 to provide mobile personal information.

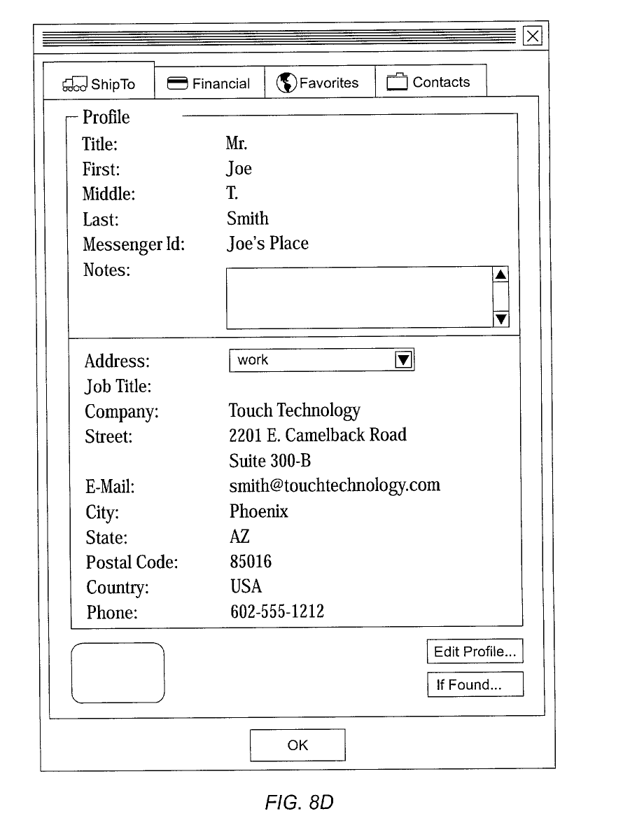

Thus, with reference again to FIG. 7, through use of user interface 410, applications 602 through 612 can be suitably displayed, such as the display of user application 750. For example, with additional reference to FIG. 8A, user application 750 can be configured to display the user contact information from user contact application 610, and/or with additional reference to FIG. 8B, user application 750 can be configured to display the user favorites information from user favorites application 606. In addition, with additional reference to FIG. 8C, user application 750 can be configured to display the user financial information from user financial application 604, and/or with additional reference to FIG. 8D, user application 750 can be configured to display the user shipping information from the user shipping application. Other exemplary display images of the various user application can also be included within various exemplary embodiments.

Moreover, in addition to displaying one or more applications 602-612 within user display 750, system 400 can provide for operation of multiple applications 602-612 at the same time, i.e., system 400 does not require user profile application 602 to be halted before user favorite application 606 or user account application 608 can be suitably initiated, operated and displayed.

In addition to the server functionality and related features, user device 410 can also be configured for facilitating secured transactions. Accordingly, system 400 for managing personal information can suitably provide various functions for securing online transactions. For example, by employing a technique that generates an authorization cryptogram for each transaction, user device 410 can suitably identify and validate the user for each application through a password protected process. In addition, during transactions, each cryptogram can be configured to be unique per transaction occurrence, and thus can only be produced or received with a valid smart card device 410. To facilitate these security features, system 400 can also be configured with a security module.

For example, a security module can include an interface that operates as a secure mechanism for storage of cryptographic keys, including, for example, software modules that perform cryptographic functions. The interface is suitably configured to be flexible to allow interfacing to an external secure device, such as a smart card 410, or to an internally installed component, such as a crypto board.

Moreover, various other security features can be implemented in accordance with various exemplary embodiments of the present invention, such as those disclosed in U.S. Application Ser. No. 09/894,252, entitled, “Method And System For Managing Transactions” and having common inventors and assignees.

The present invention has been described above with reference to various exemplary embodiments. However, changes and modifications may be made to the exemplary embodiment without departing from the scope of the present invention. For example, the various interface devices and communication components may be implemented in alternate ways depending upon the particular application or in consideration of any number of performance criteria associated with the operation of the system. In addition, the techniques described herein are not limited to use over the Internet and may be extended or modified for use with other modes of communicating data information. Moreover, while various of the exemplary embodiments illustrate the use of a smart card device, it should be noted that various other user devices configured for performing similar functions can also be implemented. These and other changes or modifications are intended to be included within the scope of the present invention, as set forth in the following claims.

1. A system for managing personal information, said system comprising:
a host server comprising a computer system for managing, storing and retrieving user data relating to the personal information;
an access device comprising a local computing device configured for storing and displaying said user data, said access device having an interface module;
a communication network configured for transferring said user data between said host server and said access device; and
an user device comprising an intelligent mobile device configured to communicate through said interface module to said access device, wherein said interface module enables server-like functionality to a plurality of applications residing on said user device.

2. A system according to claim 1, wherein said user device suitably comprises a smart card device having server-like functions configured for said plurality of applications.

3. A system according to claim 1, wherein said access device comprises a data access interface configured to provide for the storage of said user data independent of a particular type of user device and independent of a format of said user data.

4. A system according to claim 1, wherein said plurality of applications comprises a user profile application configured for storing one or more user profiles.

5. A system according to claim 4, wherein said plurality of applications comprises a user financial application configured for storing one or more credit card profiles.

6. A system according to claim 4, wherein said plurality of applications comprises a user favorites application configured for managing of URL information for one or more web sites.

7. A system according to claim 4, wherein said plurality of applications comprises a user account application configured for storing data relating to account balances.

8. A system according to claim 4, wherein said plurality of applications comprises a user contact application configured for managing contact information for others.

9. A system according to claim 1, wherein said host server comprises:
a host application component comprising a selected application;
at least one data processing component configured for processing of the personal information; and
at least one data storage components configured for storage of said data locally.

10. A system according to claim 1, wherein said communication network comprises an IP network.

11. A system according to claim 2, wherein said access device comprises:
an accepting device configured for facilitating communications between said user device and said access device; and
a processing component for processing of said data.

12. A system according to claim 2, wherein said interface module comprises a smart card interface configured for interfacing to accepting device to receive and transmit command signals.

13. A system according to claim 12, wherein said smart card interface comprises a plurality of smart card communication schemes configured for supporting a plurality of smart card devices.

14. A system according to claim 2, wherein said access device comprises a data access interface including a data storage component being configured for storage of said user data independent of a format of said user data and storage details of said user device.

15. A system according to claim 14, wherein said access device further comprises a user interface configured for display of said at least one of said plurality of applications.

16. A system according to claim 9, wherein said access device further comprises a data management component including an information processing application configured for interpreting a context of said data.

17. A system for managing personal information, said system comprising:
an access device comprising a local computing device configured for storing and displaying user data relating to the personal information, said access device being configured for communication with a host server, said access device having an interface module; and
an user device comprising an intelligent mobile device configured to communicate through said interface module to said access device, wherein said interface module enables server-like functionality to a plurality of applications residing within said user device.

18. A system according to claim 17, wherein said user device suitably comprises a smart card device having server functions configured for said plurality of applications.

19. A system according to claim 17, wherein said access device comprises a data access interface configured to provide for the storage of said user data independent of a particular type of user device and independent of a format of said user data.

20. A system according to claim 17, wherein said plurality of applications comprises a user profile application configured for storing one or more user profiles.

21. A system according to claim 20, wherein said plurality of applications comprises a user financial application configured for storing one or more credit card profiles.

22. A system according to claim 20, wherein said plurality of applications comprises a user favorites application configured for managing of URL information for one or more web sites.

23. A system according to claim 20, wherein said plurality of applications comprises a user account application configured for storing data relating to account balances.

24. A system according to claim 20, wherein said plurality of applications comprises a user contact application configured for managing contact information for others.

25. A system according to claim 17, wherein said access device comprises:
an accepting device configured for facilitating communications between said user device and said access device; and
a processing component for processing of said data.

26. A system according to claim 17, wherein said access device comprises a data access interface including a data storage component being configured for storage of said user data independent of a format of said user data and storage details of said user device.

28. A system according to claim 17, wherein said access device comprises a smart card interface including a plurality of smart card communication schemes configured for supporting a plurality of smart card devices.

29. A system according to claim 17, wherein said access device further comprises a user interface configured for display of at least one of said plurality of applications.

30. A system according to claim 25, wherein said processing component comprises an information processing application configured for interpreting a context of said data.

31. A method for the managing of personal information, said method comprising the steps of:
interfacing a user device with an access device configured to display at least one user application;
accessing said at least one user application from a plurality of applications operated through a server-like function within said user device, said server-like function enabled by an interface module of said access device;
communicating through a communication network to a host server to access a selected application resident on said host server; and
conducting a transaction between said user device and said host server using said at least one user application and said selected application of said host server.

32. The method according to claim 31, further comprising the step of storing user data within a data storage component of said access device, wherein said step of storing is conducted independent of a format of said user data and a configuration of said user device.

33. The method according to claim 31, wherein said step of accessing said at least one user application comprises accessing a user profile application configured for storing one or more user profiles.

34. The method according to claim 33, wherein said step of accessing said at least one user application comprises accessing a user financial application configured for storing one or more credit card profiles.

35. The method according to claim 33, wherein said step of accessing said at least one user application comprises accessing a user favorites application configured for managing of URL information for one or more web sites.

36. The method according to claim 33, wherein said step of accessing said at least one user application comprises accessing a user account application configured for storing data relating to account balances.

37. The method according to claim 33, wherein said step of accessing said at least one user application comprises accessing a user contact application configured for managing contact information for others.
